(19) United States
(12) Patent Application Publication
(10) Pub. No.: US 2019/0175964 A1
(43) Pub. Date: Jun. 13, 2019

(54) RAPID DEPLOY METHOD AND SYSTEM FOR PROTECTING A BUILDING AGAINST DAMAGE BY AN APPROACHING WILDFIRE

(71) Applicant: James E. Beecham, West Palm Beach, FL (US)

(72) Inventor: James E. Beecham, West Palm Beach, FL (US)

(21) Appl. No.: 16/029,630

(22) Filed: Jul. 8, 2018

Related U.S. Application Data
(60) Provisional application No. 62/664,145, filed on Apr. 28, 2018.
(60) Provisional application No. 62/708,563, filed on Dec. 13, 2017.
(60) Provisional application No. 62/664,289, filed on Apr. 30, 2018.
(60) Provisional application No. 62/665,098, filed on May 1, 2018.
(60) Provisional application No. 62/673,929, filed on May 20, 2018.
(60) Provisional application No. 62/682,264, filed on Jun. 8, 2018.
(60) Provisional application No. 62/682,915, filed on Jun. 9, 2018.
(60) Provisional application No. 62/682,952, filed on Jun. 10, 2018.
(60) Provisional application No. 62/682,968, filed on Jun. 10, 2018.
(60) Provisional application No. 62/683,055, filed on Jun. 11, 2018.
(60) Provisional application No. 62/683,678, filed on Jun. 12, 2018.
(60) Provisional application No. 62/684,360, filed on Jun. 13, 2018.
(60) Provisional application No. 62/684,782, filed on Jun. 14, 2018.

(51) Int. Cl. A62C 2/06

(52) U.S. Cl. CPC A62C 2/06

(57) ABSTRACT

A rapid deploy method and system fir protecting a building against damage by an approaching wildfire includes rapidly deploying a durable ember-resistant cover over at least a portion of the building as wildfire approaches, and optionally deploying a temporary fire-suppression wall, configured to stop or deflect or slow winds, and reduce heat and repel embers of an approaching wildlife. Advantageously, the durable fire-suppression wall, optionally built with a number of mobile wall sub-units, is designed to be transported by a single user. Each mobile wall sub-unit optionally includes a vertical wall section and a flared base section designed to provide a solid base and hold an internal tank configured to store a fire-suppression substance. A spray assembly positioned on each sub-unit is designed to spray the fire-suppression substance. The over-the-building cover, optionally comprised of stainless-steel wire mesh fabric, may be placed over the building without contemporaneous wall deployment if exigent circumstances.

### CROSS-REFERENCE TO RELATED APPLICATIONS

The present application claims priority to U.S. Provisional Application Ser. No. 62/664.145 filed on Apr. 28, 2018 entitled “Method and System for Fire-Suppression of spot-fires near to home comprising use of artificial intelligence”, U.S. Provisional Application Ser. No. 62/708,563 filed on Apr. 30, 2018 entitled “A System and Method for Fire Suppression via Artificial Intelligence”, U.S. Provisional application No. 62/664,289 filed Apr. 30, 2018, entitled “Method and System for home specific fire-risk rating and protection from wildfire”, U.S. Provisional application No. 62/665,098 filed May 1, 2018, entitled “Method and System for Fire-protective enclosure over home”, U.S. Provisional application No. 62/665,098 filed May 1, 2018, entitled “Method and System of Rapidly Re-Configurable Fire-blanket/Frame assembly”, U.S. Provisional application No. 62/673,929 filed May 20, 2018, entitled “Method and System for Protecting User Real Estate from Fire Damage”, U.S. Provisional application No. 62/682,264 filed on Jun. 8, 2018, entitled “Method and System for home-owner activated, artificial intelligence based, reduction of risk of spread of approaching wildfire within near-home vegetation”, U.S. Provisional application No. 62/682,915 filed on Jun. 8, 2018 entitled “Method and System for coordinating spray application on near-home vegetation of material suitable to suppress risk of spread of wildfire”, U.S. Provisional application No. 62/682,952 filed on Jun. 10, 2018, entitled “Method and System for deploying temporary cover over home for protection against wildfire”, U.S. Provisional application No. 62/682,968 filed on Jun. 10, 2018, entitled “Method and System for alerting real estate owner and arranging defense against wildfire risk to his property from vicinity-designated wildfire”, U.S. Provisional application No. 62/683,055 filed on Jun. 11, 2018, entitled “Method and System for deploying rapidly a fire-break wall and associated over-home fire-blanket style cover”, U.S. Provisional application No. 62/683,678 filed on Jun. 12, 2018, entitled “Method and System to improve efficiency of, and public reputation of, fire-protective means”, U.S. Provisional application No. 62/684,360 filed on Jun. 13, 2018, entitled “Method and System for rapid deployment of semi-transparent stainless steel mesh cover over building as protection against fire spread from flying embers”, and U.S. Provisional application No. 62/684,782 filed on Jun. 14, 2018 entitled “Method and System for rapid deployment of fire-spread-suppressive barrier with fire-suppressant spray”, the disclosures of which are hereby incorporated in their entirety at least by reference.

### BACKGROUND OF THE INVENTION

### 1. Field of the Invention

The present invention generally relates to methods and systems for fire suppression and more particularly to rapid deploy method and system for protecting a building against damage by an approaching wildfire.

### 2. Description of Related Art

Current scientific understanding of fire ecology, for example as applied within most of North America, states that wildfire is a natural process which under control should not be, and in fact cannot be, completely excluded. At the same time, homeowners who live in and adjacent to the wildland fire environment are responsible for personally ensuring that their homes have sufficient protection from wildfire. Such standard measures for protection can include location of home so as to have a cleared safe zone around, and construction of that home using, as much as practical, non-combustible materials, and routine clearing away of dry brush on the property—especially within 100 feet radius of the house. Nevertheless, it is well known that wildfire can approach quickly, catching some unawares. For example, wildfire can move from vegetative fuels to structures rapidly. The wind is a major factor as are the three widely recognized ways of fire spread: by radiation—heat coming from fire's energy in rays or waves such that most of the preheating of fuels ahead of a fire is by radiation (Heat Transfer, Auburn University); by convection—movement of heated air can supply more oxygen to a fire; and by firebrands—floating airborne embers. Consequently, an improved means to protect a home from wildfire damage is needed.

### BRIEF SUMMARY OF THE INVENTION

In one embodiment of the present invention a rapid deploy system for protecting a building against damage by an approaching wildfire is provided, the system comprising a fire-suppression wall configured to stop or slow an approaching wildfire's ability to damage the building, the fire-suppression wall optionally comprising a number of mobile wall sub-units, wherein each mobile wall sub-unit includes a vertical wall section and a base section, the fire-suppression wall configured to be installed at least upwind of the building; optionally with an internal tank positioned in the base section configured to store a fire-suppression substance; a spray assembly comprising a spray nozzle in fluid conductivity with the internal tank, the spray nozzle configured to spray the fire-suppression substance on at least a portion of real estate where the building is located; and, a cover comprised of stainless-steel wire mesh fabric configured to be placed over at least a portion of the building.

In one embodiment, the base section is flared. In one embodiment, the number of mobile wall sub-units is configured in a partial circumferential array. In another embodiment, the number of mobile wall sub-units is configured in a circumferential array surrounding the building. In one embodiment, each mobile wall sub-unit is curved. In one embodiment, a plurality of in-ground anchors is provided, wherein the anchors are installed pre-wildfire, generally in the form of in-ground anchors at least partially surrounding the building, the plurality of anchors configured, in approaching-wildfire use, to prevent the number of mobile wall sub-units from movement during wind. In yet another embodiment, the base section includes at least one anchor point. In one embodiment, a stainless steel cable is provided, the cable is configured to connect and secure the at least one anchor point to at least one of the plurality of in-ground anchors. In one embodiment, each mobile wall sub-unit includes wheels. In another embodiment, the wheels are positioned underneath one side of the base, such that the mobile wall sub-unit may be tipped and rolled when transported. In yet another embodiment, the spray assembly includes a temperature probe configured to actuate the spray nozzle when a predetermined temperature is reached. In one embodiment, each mobile wall sub-unit is configured to be placed and/or attached to each adjacent mobile wall sub-unit such that there is no gap between adjacent mobile wall sub-units. In one embodiment, each mobile wall sub-unit includes a front surface constructed of reflective aluminum.

In another aspect of the invention, a rapid deployment fire-suppression method for protecting a building from a wildfire is provided, comprising steps: (a) installing a plurality of in-ground anchors forming a circle of anchors surrounding the building; (b) placing a temporary fire-suppression wall upwind of the building, the temporary fire-suppression wall comprised of a number of mobile wall sub-units, each mobile wall sub-unit having a vertical section and a flared base section having an internal tank; (c) anchoring each mobile wall sub-unit to at least one in-ground anchor of the plurality of in-ground anchors; (d) filling the internal tanks for each mobile wall sub-unit with a fire suppressant substance; and, (e) spraying the fire-suppressant substance via a spray nozzle on at least a portion of real estate where the building is located.

In one embodiment, a step is provided of placing a cover comprised of stainless-steel wire mesh fabric over at least a portion of the building.

In one embodiment, the fire-facing wall of sub-units has at a centermost fire-facing aspect a ‘point of attack’ forward angled aspect or edge, wherein the wind passing such edge of wall is divided into dual streams, one passing left and the other passing right of the anchored ‘prow’ of the said forward angled wall feature.

In an alternate embodiment, the wall sub-unit comprises a segment or length of standard metal fencing having attached metal poles at either end for support in deployment as a portion of the wall. In this metal fencing on poles alternate embodiment, the in-ground anchor points comprise buried concrete bases with each a post-hole space centrally located and fitted to admit as snug fit, and typically in vertical position, the metal pole. Post holes are kept under plastic cover when not in use. During use, these post-holes are rapidly exposed during approach of wildfire by user rapidly removing said plastic covers, and then quickly and snugly fitting said fencing sub-unit support poles into place. Such rapid and stable deployment of wall sub-unit fencing segments, side by side and fitted with wind blocking/wind deflecting metal slats or alternatively configured with fine or medium metal mesh on wind-facing surfaces, is useful to deflect incoming wind and heat and flame and embers of approaching wildfire. Optionally, such fencing segment is deployed having an aluminum foil layer over front, at least on the side facing the incoming wildfire. A prow arrangement for such supported fencing sub-unit segments is enabled by angled arrangement of post-hole anchor supports. Setting ahead of time the direction of such an angled array of in-ground anchors prior to wildfire season is feasible based on scientific study and data as to likely prevailing wind direction for future approaching wildfire at said building location, such as using data based on local topography and/or regional data.

When wildfire-driving-wind approaches from unexpected direction, user can apply an alternate embodiment of instant invention wherein concrete bases are mounted on wheeled dollies, each concrete base having similar post-hole centrally within concrete. User first maneuvers at least one dolly to optimum location at site of building location, i.e. directly upwind of building, then sets the base as desired, and thus is enabled to place at least one support pole of wall segment into post-hole at optimum prow point for the present and specific incoming wildfire-wind direction.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a rapid deploy system for protecting a building against damage by an approaching wildfire according to an embodiment of the present invention;

FIG. 2 is a detailed section view of a wall sub-unit of the rapid deploy system for protecting a building against damage by an approaching wildfire according to an embodiment of the present invention; and,

FIG. 3 illustrates a protection cover of the rapid deploy system for protecting a building against damage by an approaching wildfire according to an embodiment of the present invention.

### DETAILED DESCRIPTION OF THE PREFERRED EMBODIMENT

The following description is provided to enable any person skilled in the art to make and use the invention, and sets forth the best modes contemplated by the inventor of carrying out his invention. Various modifications, however, will remain readily apparent to those skilled in the art, since the general principles of the present invention have been defined herein to specifically provide a rapid deployment fire-damage suppression system and method for expeditiously protecting a building from wildfire damage.

The word “a” is defined to mean “at least one.” The words “fire-fighting” and “fire-suppression” are defined as “reducing potential damage from an approaching wildfire.” The word “wildfire” is defined as “a large, destructive fire that begins outside the home and spreads quickly over woodland or brush, typically aided in spread by dry, hot and windy conditions.” The word “building” may be defined as “any home, building, or structure.”

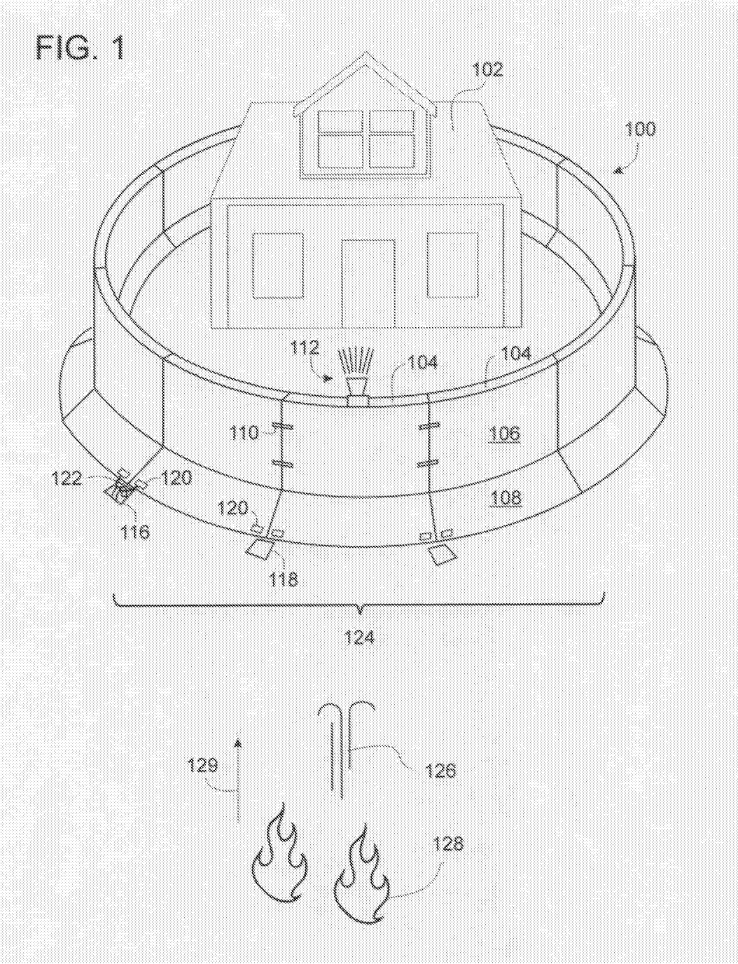

FIG. 1 is a perspective view of a rapid deploy system for protecting a building against damage by an approaching wildfire according to an embodiment of the present invention. Referring to FIG. 1, the rapid deployment fire-suppression system comprises a fire-suppression wall 100 consisting of a number of wall sub-units 104. Preferably, each wall sub-unit is identical, however it should be understood that some components and features have been removed for clarity. In one embodiment, each wall sub-unit comprises vertical wall section 106 and base section 108. In one embodiment, the base section is angled or flared out on one or both sides of the wall. This will be described in further detail below. In one embodiment, internal bracing with welded steel rods onto sub-unit comprised of 304 stainless steel of gauge 16 or the like is provided.

In one embodiment, the fire-suppression wall is configured in a circumferential arrangement surrounding a building 102, such as a house. Advantageously, this configuration provides protection from approaching wildfires at various directions and wind conditions. In one embodiment, the fire-suppression wall acts as a firebreak, to slow or stop the progress of the wildfire or lessen its damage. The use of reflective aluminum enables improved heat reflection away from the protected building, such as a layer of aluminum foil deployed over the front facing stainless steel sheet or standard metal chain-link or other fencing type. Although, each wall sub-unit is illustrated as curved in FIG. 1, it is understood that the shape may be varied. For instance, a straight shape may be provided. Further, in some embodiments, only a partial circumferential array is necessary for fire-damage suppression. For instance, if a wildfire 128 is approaching from a single direction 129 based on wind conditions 126, a partial circumferential array 124 of wall sub-units or forward-angled prow-style fencing with straight or curved sides lateral to the forward edge, and with at least partial aluminum foil reflective front may be rapidly set up by a user upwind towards the approaching wildfire direction, i.e. upwind from the protected building. Even if a full circumferential arrangement is desired, the user should start with an upwind partial circumferential array to provide the quickest protection. The steps to rapidly deploy the fire-suppression wall will be discussed in further detail below.

The benefit to a curved surface or prow-style of the wall sub-unit, is that when the curved or edged surface is facing the wind, the wind direction can be subtly altered, such as to induce turbulence, or deflect the force of wind without damage to the wall itself, or alternatively to maintain laminar flow but boost the elevation or lateral deflection of such laminar flow to extend embers around and/or downwind of the home.

In one embodiment, a plurality of in-ground anchors is provided 116, forming a circle of anchors around the house. The in-ground anchors are installed by the homeowner pre-fire, so as to be ready for use when needed. A plastic cover for the anchor 118 is provided when anchor is not in use, to protect the anchors from debris accumulation between uses, and such cover is low in outline, thus not obstructing mowing grass or the like. During use, each wall sub-unit should be positioned between two in-ground anchors. A pair of anchor points 120 is provided on the base section of each wall sub-unit. A link chain or stainless steel cable 122 is provided to anchor down each wall sub-unit via the in-ground anchors and anchor points, thus preventing the wall sub-units from movement during wind. This is critical, as wind in some highly wildfire-prone areas, such as California, can reach 70 miles per hour, driving and spreading wildfire quickly. Preferably, the in-ground anchors are engineered to allow optimum resistance to wind, and rapid snap or snug attachment capabilities, such as via cable 122 are provided.

In one embodiment, if desired, each wall sub-unit may be linked and joined to an adjacent wall sub-unit via an attachments means 110. The attachment means may be any temporary attachment method as well known in the art. In one embodiment, the linking of wall sub-units is optional. The critical aspect, in one embodiment, whether the wall sub-units are joined to adjacent wall sub-units or not, is that there is a snug fit provided between adjacent wall sub-units to prevent any openings where embers could traverse the wall. Those embers able to surmount the wall are typically defeated by the fire-resistant tarp or stainless steel wire mesh fabric protective cover over the protected building, which will be described in greater detail below. In addition to embers, the present invention protects against smoke and ash damage. This is a particular advantage of the present invention, as insurance companies may not include protection from smoke and ash damage in insurance policies. In some embodiments, the use of the in-ground anchors secures each adjacent wall sun-unit such that a snug and wall-stabilizing fit is provided.

In one embodiment, on a top portion of each sub unit, a spray assembly 112 is provided. The spray assembly is configured to spray a fire-suppressant liquid upwards and/or towards the home when a temperature probe (not illustrated) on the exterior of the sub-unit detects a high temperature, such as a temperature indicating a likely wildfire is in range of the location.

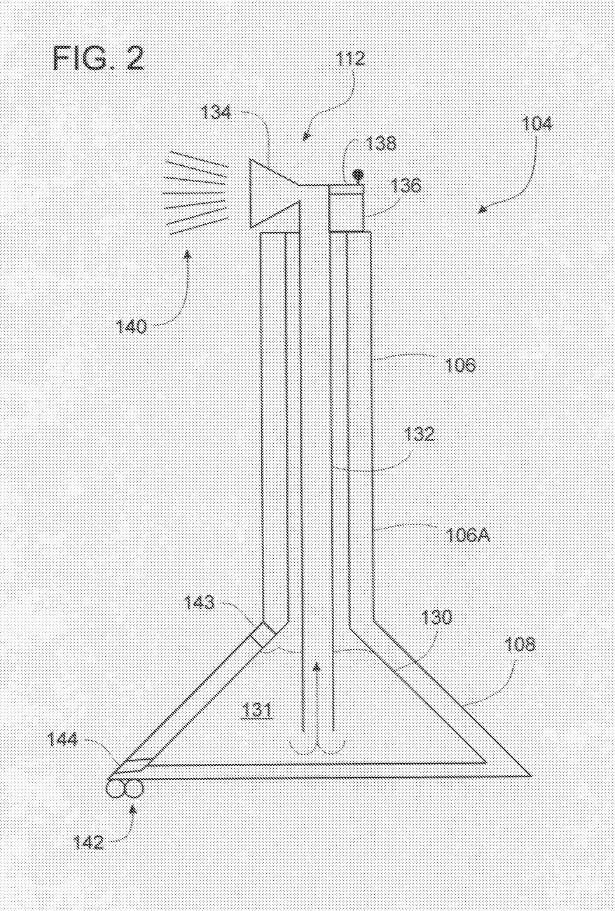

FIG. 2 is a detailed section view of a wall sub-unit 104 of the rapid deploy system for protecting a building against damage by an approaching wildfire according to an embodiment of the present invention. Referring now to FIG. 2, the profile of the wall sub-unit is illustrated, showing the internal components. In one embodiment, base section 108 comprises an internal tank 130 configured to hold a fire-suppressant substance 131, such as a liquid base substance, water-gel, or other fire-suppressant substances known in the art. In one embodiment, an agitator (not illustrated) may be provided to stir and mix the fire-suppressant substance. An internal conduit 132 extends from the internal tank through vertical wall section 106 to the top of the wall sub-unit to a spray nozzle 134. In one embodiment, a pump 136 is provided to pull the fire-suppressant substance from the tank and out the nozzle, releasing the fire-suppressant substance 140 into the environment to control and suppress fires and embers and the like. In one embodiment, a control system 138 is provided. The control system includes the temperature probe, a battery, a timer, and actuators. As previously mentioned the temperature probe is configured to trigger the activation of the pump when a pre-determined temperature is exceeded, wherein the pre-determined temperature is a temperature that would indicate a wildfire is present or approaching. The battery is configured to provide power to the pump, and any other components that may require power. The timer is configured to activate the agitator in pre-determined intervals in order to keep the tank's contents in working order.

The fire-suppressant substance is configured to be released and directed from the nozzle in an upward, straight, or optionally downward motion, or a combination thereof. By such spray, directed upwards, the passing air takes some of the liquid and applies it to passing ember. By such spray, directed downwards, the vegetation inwards from wall to home site, or the tarp or wire mesh cover of the protected house, is doused with fire-resistant substance so as to improve its ability to resist fire from embers or the like. In one embodiment, the externally exposed components of the spray assembly may be optionally lodged in a fire-resistant and heat-resistant shell or blanket. Similarly, the control unit, and especially the battery are protected from high temperatures. In additional to the temperature probe, the user may manually activate the pump.

It is a particular advantage of the present invention to provide wheels 142 on the bottom of each wall sub-unit such that the sub-units may be readily and rapidly positioned and transported. In one embodiment, each wall sub-unit is equivalent to a two story height structure, i.e. approximately 20′. In one embodiment, the wheels are provided on the house-facing side. Using these wheels, a user can tilt the very tall wall sub-unit, drag or push it by a handle (not illustrated) which protrudes from the upper aspect, and still make quick time from garage or other storage to site for setting the sub-unit, such quick time enabled by the wheels allowing speed in transit. When transporting the sub-unit, the internal tank is preferably empty, as the fire-suppressant substance weighs down the wall-sub unit significantly. Removable plugs 143 and 144 may be provided to supply and drain the internal tank respectively, optionally filling rapidly from a mobile wheeled reservoir/spout tank (not shown). In one embodiment, an optional brace (not shown) may be provided between the wall sub-unit and the building structure or foundation further steadying the wall sub-unit against movement in wind.

In one embodiment, the wall sub-units include or comprise a metal wire or chain-link or similar fence component over which is placed reflective aluminum foil as a layer at least on the surface facing the approaching fire.

In one embodiment, the wall sub-units include a surface constructed of reflective aluminum on the side facing the approaching fire (front surface 106A). Based on laboratory test data, the presence of highly reflective aluminum enables the reduction of radiant heat by the sub-unit up to the 98% level of heat reduction. Other coatings or surface materials are also contemplated. In one embodiment, the wall sub-unit is constructed from stainless steel, such as Austenitic steel rated for high temperature use, such as the 300 series or 200 series of stainless steel. Further details for Austenitic stainless steel may be found in the “Characterization of Austenitic Stainless Steels Deformed at Elevated Temperature”, Calmunger et al, disclosed at least by reference.

The spray assembly is optionally enabled for remote activation. Optionally, the link to the signal for activation remotely, as typically accomplished by well-known means of the art, such as cell phone link or satellite or the like, can be image related. In this embodiment, the image analysis, such as from a camera mounted at the house, those images if capturing ember images in the air nearby, such enable the activation of nozzle spray. This image analysis is optionally performed via machine learning software on a linked central computer, with outgoing signal to the spraying assembly of all wall sub-units.

As previously mentioned, the wall sub-unit has, in one embodiment, a flared triangular base section. The increase of surface area provides a stable base required when having a tall vertical wall section, and provides a cavity for the internal tank. It should be understood, that the figures are not to scale, and that the proportions between the base and the vertical section may be different than illustrated.

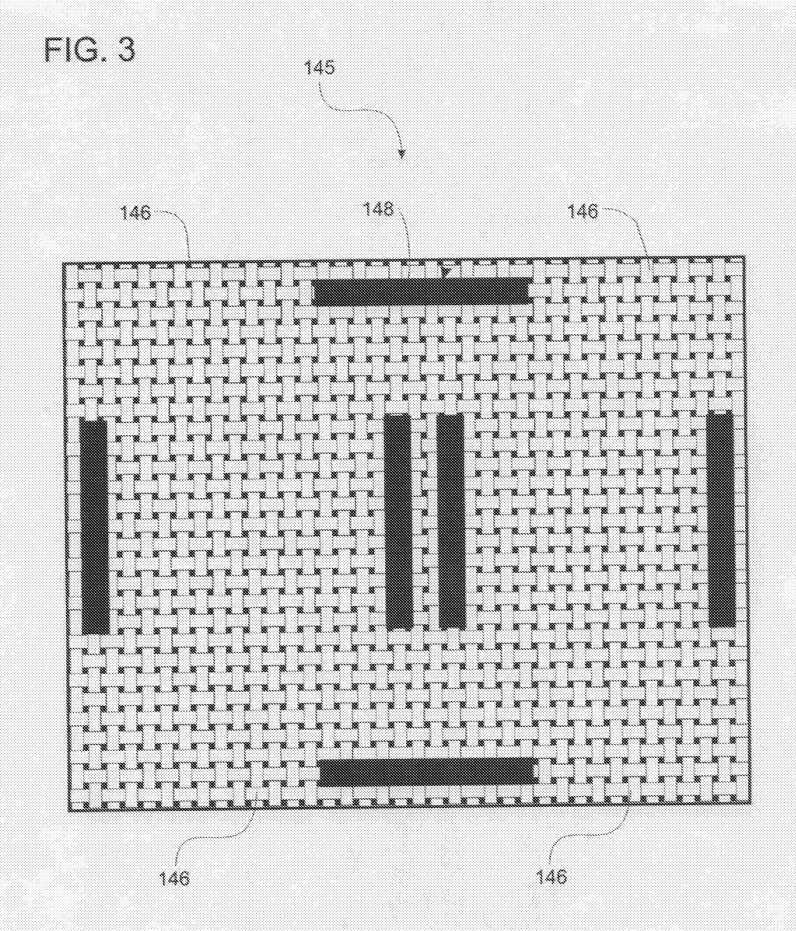

FIG. 3 illustrates a protection cover 145 of the rapid deploy system for protecting a building against damage by an approaching wildfire damage according to an embodiment of the present invention. Referring now to FIG. 3, the protection cover is illustrated. The cover comprises one or more pieces 146 of fire-resistant fabric creating a single layer continuous protection cover. It one embodiment, the continuous single layer is configured to be positioned over home for additional fire protection, optionally in combination with deployment of the fire-suppression wall. In one embodiment, the cover is comprised in a custom fit via metal-clip joining together 148 the one or more pieces, and fitted to roof and side wall dimensions of the house from measurements taken beforehand, i.e. constructed prior to time of first approaching-wildfire application. The metal-clip joining together of the one or more pieces is especially useful since current looms do not generally produce stainless steel fabric as wide in cover capacity as many home roofs and sidewalls require. In one embodiment, after placement over building, spraying stainless steel fabric cover with water gel prior to arrival of wildfire/wildfire embers is envisioned to further improve performance of system in damage control.

In one embodiment, the fire-resistant fabric is constructed of 304 stainless steel wire square weave fabric, optimally 0.009 inch diameter stainless steel 304 wire or similar, and optimally 0.0466 inch stainless steel 304 weave fabric apertures size known as 18 mesh, or similar. In one embodiment, each square foot of the 304 stainless square weave fabric weighs approximately 0.1 pounds making it suitable for rapid transport, small team setup, and efficient use/re-use. It should be understood, that a variety of other weave types (square weave, Dutch weave, etc.) and other mesh specifications are envisioned to be useful herein. Among these are medium mesh (12 to 88) and fine mesh (90 to 635). In one embodiment, the fire-resistant fabric may be welded, soldered, clipped with metal clips, or tied with heat resistant metal wire such as stainless steel 316 or 316L wire or the like.

As previously mentioned, the cover is optionally configured to be placed on the home as a combination with the fire-suppression wall. This provides extra protection in the case where embers make it through or over the fire-suppression wall. Although, the preferred cover was described, in some embodiments, fire resistant tarps available for purchase in various sizes may be used. If a premanufactured tarp is used, the material used must be approved for use based on California standards for fire-retardant fabric. It should be understood, that the materials used in the system and method may change as the technology and advancement of fire retardant textiles improves. Refer to “Recent advances for Flame Retardancy of Textiles Based on Phosphorus Chemistry”, Polymers, Salmeia et al, 2016 incorporated by reference herein. A key aspect of the use herein disclosed of stainless steel 300 series metal wire woven fabric cover over the protected building is based on inventor's documentation of improved fire-resistant characteristics thereby. For example, the standard test, as well known in the art for fire-resistant material fabric, such as tarps, when used as fire resistant, is for tester to apply a 1.5 inch long flame for 12 seconds to the mid-portion of a hanging fabric swatch, and then measure char after flame discontinuation. Typically a several inches long char is observed, indicating a burn occurring during application of the flame and shortly thereafter. However, when same test was applied by inventor to said 304 stainless steel wire mesh woven fabric swatch, in 1.5 inch flame, the results were better, i.e. yielded superior results, indicating no ‘char’ or fabric damage, and no flaming of the fabric of steel, thus indicating an improved performance in fire-resistance utility, as herein disclosed for use.

A key feature of the instant invention cover over the entire building is the means of securing the cover in place so as to prevent dislodgement during strong winds as accompany many wildfires. As disclosed in provisional 62/684,360 ‘Method and System for rapid deployment of semi-transparent stainless steel mesh cover over building as protection against fire spread from flying embers’, filed 13 Jun. 2018 at USPTO, the instant invention cover of stainless steel mesh fabric is configured optionally, such as by metal clips and wire thread, to have attached wire rope cables of stainless steel along edges and other places. These attachments enable sliding hooks to be attached onto cables of the cover, which arrangement enables rapid deployment in extending the cover and covering the building, even in high winds. Further, the disclosed cover configuration of 62/684,360 has cables thus attached along all four edges so that the cover (see FIG. 5 of 62/684,360) is fully extended even to the ground in use, placed over the entire building, where it is then secured by a variety of means, such as sandbags and by hooks attached to ground anchors and then onto the lateral edge cables, and the like. Furthermore, the edge cables are wound around the structure so as to snug the cover into the sidewalk of the building, thus further securing the cover against wind gusts and the like.

Various techniques and method may be used to install the cover on the house. In one embodiment, UAV's, cranes, or other assistance machines may be used to place the over on difficult areas, for instance to cover the roof. Poles or posts (not illustrated) may be installed to provide support and anchor locations for the cover. In one embodiment, a central post may be installed or pre-installed on the roof of the home providing a central installation maneuver point for the cover. In some embodiments, sandbags may be used to secure the cover in ground locations adjacent to all sections of the home, such as to snug to home structure and thus better resist dislodgement by wind. The preceding solutions are just some examples, and various examples as wells as disclosures and details of the cover, as for example referred to as semi-transparent stainless steel mesh or fabric or fire-blanket or enclosure or tarp, can be found in the provisional applications incorporated by reference in this application.

In circumstances where wildfire is pressing in on user's home rapidly, and therefore deployment time is limited, it is envisioned that only partial deployment is allowed by short time. In that case, the stainless steel mesh fabric cover should be deployed first, and might be the only component deployed. In that case, without wall deployed, and with wildfire approaching quickly, tightly securing the cover in place is key. The 304 stainless steel woven fabric cover can be tightly secured in place according to the details herein provided, such as with sandbags onto the cover at sides of building, thus to snug cover to exterior of home. Other means of securing or snugging cover are per standard measures known in the art, such as mentioned in cited provisional applications listed herein. This cover securing-in-place is critical to proper damage control, especially since the wall will not be in place, leaving the cover alone to deflect both heat and embers.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, in addition to 304 stainless steel, 316 stainless steel may be used or any other material that would be optimal for use in various aspects or locations of the invention.

1. A rapid deploy system for protecting a building against damage by an approaching wildfire comprising:
a fire-suppression wall configured to stop or slow an approaching wildlife, the fire-suppression wall comprising a number of mobile wall sub-units, wherein each mobile wall sub-unit includes a vertical wall section and a base section, the fire-suppression wall configured to be installed upwind of the building;
an internal tank positioned in the base section configured to store a fire-suppression substance;
a spray assembly comprising a spray nozzle in fluid conductivity with the internal tank, the spray nozzle configured to spray the fire-suppression substance on at least a portion of real estate where the building is located; and,
a cover comprised of stainless-steel wire mesh fabric configured to be placed over at least a portion of the building.

2. The rapid deploy system for protecting a building against damage by an approaching wildfire of claim 1, wherein reflective aluminum is used as a facing on at least one sub-unit.

3. The rapid deploy system for protecting a building against damage by an approaching wildfire of claim 1, wherein the number of mobile wall sub-units is configured in a partial circumferential array.

4. The rapid deploy system for protecting a building against damage by an approaching wildfire of claim 1, wherein the number of mobile wall sub-units is configured in a circumferential array surrounding the building.

5. The rapid deploy system for protecting a building against damage by an approaching wildfire of claim 1, wherein at least one of the mobile wall sub-units is curved.

6. The rapid deploy system for protecting a building against damage by an approaching wildfire of claim 1, further comprising a plurality of in-ground anchors installed pre-wildfire forming an array of anchors surrounding the building, the plurality of anchors configured in use to prevent the number of mobile wall sub-units from movement during wind.

7. The rapid deploy system for protecting a building against damage by an approaching wildfire of claim 6, wherein the base section includes at least one anchor point.

8. The rapid deploy system for protecting a building against damage by an approaching e of claim 7, further comprising a stainless steel cable configured to connect and secure the at least one anchor point to at least one of the plurality of in-ground anchors.

9. The rapid deploy system for protecting a building against damage by an approaching wildfire of claim 1, wherein at least one mobile wall sub-unit includes wheels.

10. The rapid deploy system for protecting a building against damage by an approaching wildfire of claim 1, wherein the wheels are positioned underneath at least one side of the base, such that the mobile wall sub-unit may be rolled when transported.

11. The rapid deploy system for protecting a building against damage by an approaching wildfire of claim 1, wherein the spray assembly includes a temperature probe configured to actuate the spray nozzle when a predetermined temperature is reached.

12. The rapid deploy system for protecting a building against damage by an approaching wildfire of claim 1, wherein each mobile wall sub-unit is configured to be placed and/or attached to each adjacent mobile wall sub-unit such that there is no gap between adjacent mobile wall sub-units.

13. The rapid deploy system for protecting a building against damage by an approaching wildfire of claim 1, wherein at least a portion of the wall includes a front surface constructed of reflective aluminum.

14. A rapid deploy method for protecting a building against damage by an approaching wildfire comprising a step of deploying a cover, comprised of austenitic stainless steel mesh fabric sufficient to significantly repel embers, over at least the majority of a roof of the building as a contiguous cover, said cover so deployed as wildfire is approaching said building, said cover deployment enabled by use of cable, said cover anchored then securely against being dislodged by force of wind.

15. The rapid deploy method for protecting a building against damage by an approaching wildfire of claim 14, further comprising deploying at least components of a wind-deflecting, heat-reflecting wall on building site, wherein such wall component deploying occurs during the time of approach of wildfire towards said building, and wherein said deployed wall occupies at least an upwind-of-building position.

16. A rapidly deployable fire-damage control system to protect a building from damage by approaching wildfire comprising at least one Austenitic stainless steel component within at least one of a.) a rapidly deployable cover over at least a portion of said building, or b.) at least one wall component rapidly deployable adjacent to said building and useful to at least partially deflect approaching wildfire winds away from said building.

17. The rapidly deployable fire-damage control system to protect a building from damage from approaching wildfire of claim 16, further comprising a reflective aluminum surface on at least a fire-facing portion of said wall component.

18. The rapidly deployable fire-damage control system to protect a building from damage from approaching wildfire of claim 16, wherein said stainless steel component comprises joined mesh pieces.

19. The rapidly deployable fire-damage control system to protect a building from damage from approaching wildfire of claim 16, wherein said cover further comprises a water-gel layer application in use.

20. The rapidly deployable fire-damage control system protect a building from damage from approaching wildfire of claim 16, wherein said wall comprises a prow-like feature to split incoming wind flow.
